(19) United States
(12) Patent Application Publication
(10) Pub. No.: US 2004/0165591 A1
(43) Pub. Date: Aug. 26, 2004

(54) Method of configuring a routing path in an IP router and network

(75) Inventors: Alberto Conte, Paris (FR); Stephen Chischportich, Paris (FR); Philippe Dauchy, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/736,539

(22) Filed: Dec. 17, 2003

(30) Foreign Application Priority Data
Jan. 14, 2003 (FR) 03 00 330

(51) Int. Cl. H04L 12/28; H04L 12/56

(52) U.S. Cl. 370/392; 370/401

(57) ABSTRACT

The method is used in a router (10) to configure a routing path to an address in an IP network using a routing control unit (1) separate from the router (10). The method comprises the steps of:

a) the router (10) sending the routing control unit (1) a routing path to said address (21);

b) the routing control unit (1) sending the router (10) a validation message (22); and

c) configuring the selected routing path in the router (10).

The present invention relates to a method of configuring a routing path to an address in an IP network, the method being executed in a router. It also relates to an IP network and an IP router.

The Internet interconnects a multitude of Internet Protocol (IP) networks, enabling their terminals to exchange data in the form of packets of data that are routinely referred to as datagrams. For convenience, the various IP networks interconnected in this way are referred to herein as subnetworks, to distinguish them from the Internet, which is a global network.

Routing datagrams across the Internet from a sender terminal to a destination terminal via IP routers is known in the art. Routers are devices that determine the path in the Internet that a datagram must take to reach its destination. Thus a sender terminal of an IP subnetwork connected to the Internet can send a datagram to a destination terminal connected to another IP subnetwork. To this end, a datagram sent by the sender terminal is received by a first router which reads the IP address of the destination terminal contained in the header of the datagram in order to send the datagram to the subnetwork of the destination terminal, either directly if the first router is connected to the subnetwork or otherwise via intermediate routers. Each intermediate router sends the datagram to the next router until it reaches the subnetwork to which the destination terminal is connected. The datagram is therefore transmitted successively from router to router as far as the subnetwork to which the destination terminal is connected, and is finally delivered to that terminal.

To provide for this successive transmission, each router comprises a routing table that lists the correspondences between the IP address of the subnetwork to which the destination terminal is connected and the IP address of the next router in the Internet to which it must send the datagram to be delivered to that terminal. The router determines the IP address of the IP subnetwork to which the destination terminal is connected from the IP address of the destination terminal. In fact, the IP addresses of all the entities—terminals, routers, etc. belonging to a subnetwork have a common first portion. The subnetwork can further be limited to the entities for which the remainder of their IP address belongs to a subset of the set of addresses that can have this common first portion. The IP address of a subnetwork then consists in this common first portion and the mask for discriminating the remaining portions of the IP addresses belonging to that subset.

The routing tables of the routers need to be updated as a function of modifications affecting the various IP subnetworks. Such modifications, referred to herein as routing information, can consist in particular of the connection of an IP subnetwork to the Internet or its disconnection therefrom, the existence of a new routing path to a given subnetwork, the elimination of a routing path to a given subnetwork, and the addition or removal of an IP router.

A router can employ static routing, in which case the routing table of the router is updated manually. Routing is generally dynamic, however, meaning that the routing table of the router is updated automatically by the router as a function of routing information that it receives. The update information is conveyed between the routers by means of a routing protocol that enables the router to receive the routing information to update its routing table and to share the routing information with the other routers to which the router is connected.

There are various routing protocols that can be used in particular as a function of the location of the routers in the network. Thus a distinction is generally drawn between:

exterior routers or edge routers interconnecting autonomous networks or autonomous systems, the routing protocols used with these routers including the Exterior Gateway Protocol (EGP) and the Border Gateway Protocol (BGP), and

interior routers handling routing within an autonomous network and using an Interior Gateway Protocol (IGP) such as the Routing Information Protocol (RIP) between themselves or to communicate with external routers.

Regardless of the IP router concerned and the routing protocol used, when it receives routing information, for example a new route to a given subnetwork, the router executes a routing algorithm to evaluate the benefit of the new route compared to those it already knows. If the routing algorithm concludes that the new route is more appropriate, the router immediately updates its routing table to use the new route in future if any datagrams are addressed to that subnetwork. The new route may involve the router, in future, sending datagrams to an adjoining router in the network that is not the one to which it used to send them before updating its routing table. The routing table is therefore updated autonomously by each router, using its routing algorithm, as a function of routing information that it receives from other routers, the result of which is optimum routing at the local level.

This routing method is not always satisfactory. In Phone over IP and Multimedia over IP applications it is necessary to provide a certain quality of service (QoS) to assure satisfactory transmission across the network, for example by providing sufficient bandwidth for the transmission of data. Each router, updating its routing table autonomously, can unintentionally divert the data stream toward sections of the network that are not appropriate to achieving the required quality of service. Or again, in the event of reserving resources along a given path in the network for a particular data stream, there is the risk of the router diverting the stream of data from that path, with the consequence that the reservation of resources is wasted.

Moreover, this routing method cannot flexibly manage routing across the network as a function of administrative imperatives of a commercial or similar nature. Thus a network administrator may require his data to be transmitted either avoiding or definitely using a portion of the Internet administered by some other person, as a function of an agreement entered into with the latter. The routing method cannot easily take such imperatives into consideration.

The object of the invention is to alleviate at least some of these drawbacks. Thus the invention seeks to control routing across the network, in particular to assure a certain quality of service level or to make routing of datagrams across the network flexible.

To this end, the invention proposes a method for use in a router of configuring a routing path to an address in an IP network using a routing control unit separate from the router, the method comprising the steps of:

a) the router sending the routing control unit a routing path to said address;

b) the routing control unit sending the router a validation message; and

c) configuring the selected routing path in the router.

Thus, after the selected routing path has been configured in the router, the latter sends the datagrams addressed to that destination on that path.

In a preferred embodiment, the router selects the routing path sent in step a) as a function of information received by the router and concerning routing to said address.

In another preferred embodiment, the routing control unit executes step b) at a time determined as a function of the state of the traffic in the network.

In another preferred embodiment, the routing control unit executes step b) after a data stream to be delivered to said address for which resources have been reserved along a path across the network has passed through the router.

In another preferred embodiment, the routing control unit executes step b)_ after instigating further reservation of resources along the selected routing path in the network for a data stream to be delivered to said address for which resources have already been reserved along a path across the network.

In another preferred embodiment, step c) further comprises the router sending the selected routing path to at least one other router.

In another aspect, the invention proposes an IP router comprising:

means for selecting a routing path to an IP address;

means for sending the selected routing path over the network;

means for receiving via the network a message validating the selected routing path; and

means for configuring the selected routing path in the router on receiving a validation message in respect of said routing path.

In a further aspect, the invention proposes an IP network comprising at least a router and a routing control unit separate from the router, in which network the router and the control unit employ the method according to the invention. It is advantageous if the control unit and the router communicate via the IP network.

In the context of the invention, the expression “address in an IP network” means the IP address of an IP subnetwork of the IP network or an IP address of any element connected to the IP network, such as a terminal or a router.

The fact that routers according to the invention await external validation of the routing paths that they select allows external control of the routing paths configured in one or more routers of the network, or even in all of them. This external control can be effected by a single routing control unit controlling all the controlled routers of the network. Accordingly, among other things, the invention enables centralized control of the data streams in the network. External control of the controlled routers can also be effected by one or more routing control units.

The invention is particularly advantageous because it is simple to put into practice in existing routers, and possibly routers already installed in networks. This is because it suffices to insert the steps of sending envisaged updates and awaiting external validation into the processing software of the router responsible for managing the routing paths, without modifying other physical or software elements of the router.

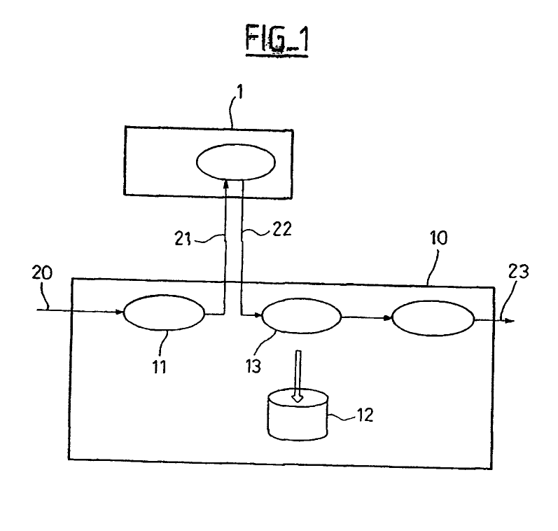

Other features and advantages of the invention will become apparent on reading the following description of preferred embodiments of the invention, given by way of example and with reference to the appended drawing, in which FIG. 1 shows diagrammatically one embodiment of the method of the invention.

The invention proposes to control the configuration of the routing paths in a router of an IP network by having the router await external validation before configuring a new routing path that it has selected. Thus validation can be provided by a routing control unit separate from the router itself. The routing control unit either grants the validation if the new routing path selected is considered acceptable or refrains from granting the validation if the new path selected by the router is inappropriate. Alternatively, the routing control unit can delay validation until the new routing path selected has become acceptable.

FIG. 1 shows a router 10 in which the updating of the routing paths is controlled by a routing control unit 1. The router 10 receives routing information 20 via the IP network in a manner that is known in the art. The routing information can in particular consist in the connection/disconnection of an IP subnetwork to/from the IP network, the existence of a new routing path across the IP network to a given subnetwork, the elimination of a routing path to a given subnetwork, or the addition/removal of an IP router to/from the IP network. The information is generally sent to the router 10 by sources connected to the IP network, including other routers. The routing information can be communicated with the aid of any routing protocol, for example EGP, BGP, IGP or RIP.

The router 10 preferably comprises a conventional routing table 12. The router 10 executes a routing algorithm 11 which, from routing information 20 received by the router 10, determines if it is appropriate to update the routing path in the routing table 12, and where applicable defines the update to be effected therein. The routing algorithm 11 can be of a type known in the art. The router 10 also conventionally comprises a module 13 for updating the routing table 12 in accordance with updates defined by the routing algorithm 11.

The updating of a routing path in the routing table 12 can consist in:

modifying a routing path to an IP address for which no route was previously configured in the router (in which case the router generally applies a default routing path),

modifying a routing path to an IP address previously configured in the router, or

eliminating a routing path to an IP address previously configured in the router (in which case the router can again apply a default routing path).

The router 10 can also conventionally comprise a module 14 for deciding if it is appropriate to send the updated routing path to one or more other routers or devices connected to the network. This sending is symbolized by the arrow 23 and can be effected in a manner that is known in the art. The functions of the module 14 can in particular be executed conventionally after the module 13 has updated the routing table.

The router 10 sends the updates to the routing paths in the routing table 12 defined by the routing algorithm 11 to the routing control unit 1. This sending is symbolized by the arrow 21.

The module 13 for updating the routing table does not carry out the update defined by the routing algorithm 11 until the router 10 has received a validation message from the routing control unit 1. Consequently, the module 14 does not send the routing information to the other devices of the network until the router 10 has received the validation message either. The sending of the validation message by the routing control unit 1 is symbolized by the arrow 22.

When the router 10 receives the validation message, the module 13 updates the routing table 12 in accordance with the update defined by the routing algorithm 11 and, where applicable, the module 14 sends the updated routing path to other devices of the network.

For simplicity, communication between the routing control unit 1 and the router 10—in particular for sending envisaged update messages 21 and validation 22—is effected via the IP network itself. Alternatively, communication between the routing control unit 1 and the router 10 can be effected via a cable link or via another network, separate from the IP network in which the router 10 handles routing.

Accordingly, the routing control unit 1 can check if the updating of the routing table defined by the routing algorithm 11 is acceptable or not. If it is acceptable, the routing control unit sends the validation message 22 to the router 10, the consequence of which is to update the routing table 12. On the other hand, if the update defined by the routing algorithm 11 is not acceptable, the routing control unit 1 does not send a validation message and consequently the update is not effected in the routing table 12. To achieve this, the routing control unit 1 can simply remain silent after receiving the envisaged update 21. Alternatively, the routing control unit 1 can send an invalidation message instead of remaining silent.

In a particularly advantageous variant, the validation message 22 consists in the envisaged update 21 itself. In other words, when it considers an update of a routing path defined by the routing algorithm 11 to be acceptable, the routing control unit 1 sends that update to the router 10. The module 13 then installs the update received by the router 10 in the routing table 12 and the module 14—if present—executes its functions. This variant implicitly defines the correspondence between the validation message 22 and the envisaged update 21.

The routing control unit 1 can also determine the most opportune time to update the routing paths in the router 10, possibly by delaying sending of the validation message 22.

The decision whether or not to update the routing configuration of the router 10 and the choice of when to effect the update can therefore take into account quality of service criteria or IP network datagram administration policies.

The IP network administration rules implemented by the routing control unit 1 can be received from a network management system (NMS) or a system for managing service level agreements (SLA) entered into with neighbors, i.e. administrative entities managing or controlling an IP domain adjacent that of the routing control unit, and can further comprise predetermined rules relating to traffic engineering in the network configured directly in the control unit 1.

As already mentioned, the routing control unit 1 can delay installation of the envisaged routing path update 21 in the router 10, for example to take account of the status of the traffic in the network, in particular to wait for the traffic conditions in the network to allow modification of the routing paths without causing problems.

Thus a QoS controller known in itself may have previously reserved resources along a path across the network including the router 10 to a destination address for a particular data stream; for example it may have allocated memory in the routers on that path to receive and transmit the data stream. Although the data stream has not yet been delivered in full to the destination address, it is possible for the router 10 to receive routing information 20 indicating the existence of another routing path to that destination address. If the routing algorithm 11 selects the other path to be installed in the routing table 12, it is preferable for the routing control unit 1 to delay the corresponding updating of the routing table 12 by the module 13 by not sending the validation message 22 for that path to the router 10 immediately. This is because there is the risk of the data stream taking by default a path different from that along which resources have been reserved.

A first way to avoid this problem is for the routing control unit 1 to delay sending the validation message 22 until the data stream has passed completely through the router 10. The installation of the new routing path in the routing table 12 of the router 10 is thus delayed until all of the data stream has passed through the router 10. The routing control unit 1 can simply be informed by the QoS controller that all of the data stream concerned has passed through the router 10. The QoS controller is informed that all of the data stream concerned has been delivered to the destination address so that it can terminate the reservation of resources, which are no longer of any utility. Thus the data stream is routed along the original path, along which resources had actually been reserved.

A second way to avoid this problem is for the routing control unit 1 to send the validation message 22 and to request reservation of resources along the new path. To this end, the routing control unit 1 can ask the QoS controller to reserve resources along the new path. To this end, the routing control unit 1 informs the QoS controller of the definition of the new path. When the reservation is made, the QoS controller informs the routing control unit 1 of it, and the latter then sends the router 10 the validation message 22. The module 13 of the router 10 then writes the new path into the routing table 12. Consequently, the data stream concerned takes the new path, along which resources have been reserved.

Of course, with either option, the routing control unit 1 can be informed of the reservation of resources by the QoS controller.

A third way to avoid this problem is for the routing control unit 1 to send the QoS controller the new routing path defined by the routing algorithm 11 and await a validation message from the latter before itself sending a validation message 22 to the router 10. In this way, the QoS controller can verify if the new routing path affects any existing reservation of resources. If it does not, the QoS controller sends the validation message to the routing control unit 1, preferably immediately, which unit in turn sends the validation message 22 to the router 10. If it does affect an existing reservation of resources, the QoS controller reserves resources along the new path. Once the resources have been reserved, the QoS controller sends the validation message to the routing control unit, which in turn sends the validation message 22 to the router 10.

Thus the routing control unit 1 instigates the reservation of resources by the QoS controller when either the second or the third of the above procedures is followed.

The above three ways to avoid the problem previously cited are no more than preferred examples.

Moreover, the QoS controller and the routing control unit 1 can constitute one and the same physical entity, in other words be implemented with common electronics. However, they can also be two distinct physical entities that then communicate with each other, preferably via the IP network.

Of course, the present invention is not limited to the examples and embodiments described and shown, and lends itself to many variants that will be evident to the person skilled in the art. Thus the same routing control unit can control a plurality of routers of the IP network.

The method of the invention can control the routers regardless of their location within their network, in particular of whether they are external or internal routers.

Moreover, the routing information 20 can come from any kind of source, such as a Network Management System (NMS). Via the network, an NMS can initialize routing paths in the router when it is put into service in the network. The initialization data sent by the NMS to the router 10 can therefore be kept by the routing control unit 1, which will prevent an acceptable routing path being configured in the router 10.

Finally, a routing control unit can form a physical entity separate from the other elements connected to the IP network. However, it can also be integrated into another unit connected to the network. Thus it can be integrated into an NMS. It can also be integrated into a router of the IP network, so that other routers of the IP network can then be controlled.

1. A method for use in a router (10) of configuring a routing path to an address in an IP network using a routing control unit (1) separate from the router (10), the method comprising the steps of:
a) the router (10) sending the routing control unit (1) a routing path to said address (21);
b) the routing control unit (1) sending the router (10) a validation message (22); and
c) configuring the selected routing path in the router (10).

2. A method according to claim 1, characterized in that the router (10) selects the routing path sent in step a) as a function of information (20) received by the router and concerning routing to said address.

3. A method according to claim 1, characterized in that the routing control unit (1) executes step b) at a time determined as a function of the state of the traffic in the network.

4. A method according to claim 1, characterized in that the routing control unit (1) executes step b) after a data stream to be delivered to said address for which resources have been reserved along a path across the network has passed through the router (10).

5. A method according to claim 1, characterized in that the routing control unit (1) executes step b) after instigating further reservation of resources along the selected routing path in the network for a data stream to be delivered to said address for which resources have already been reserved along a path across the network.

6. A method according to claim 1, characterized in that step c) further comprises the router (10) sending (23) the selected routing path to at least one other router.

7. An IP router comprising:
means (11) for selecting a routing path to an IP address;
means for sending the selected routing path (21) over the network;
means for receiving via the network a message (22) validating the selected routing path; and
means (13) for configuring the selected routing path in the router on receiving a validation message in respect of said routing path.

8. An IP network comprising at least a router (10) and a routing control unit (1) separate from the router, in which network the router and the control unit employ the method according to any one of claims 1 to 6.

9. An IP network according to claim 8, characterized in that the control unit (1) and the router (10) communicate via the IP network.
